(19) United States
(12) Patent Application Publication
(10) Pub. No.: US 2015/0120020 A1
(43) Pub. Date: Apr. 30, 2015

(54) WEARABLE ACTIVITY MONITORING DEVICE SECURED BY A WRISTBAND WITH AN INTERCHANGEABLE SECTION

(71) Applicant: JayBird LLC, Salt Lake City, UT (US)

(72) Inventor: Judd Armstrong, Parrearra (AU)

(73) Assignee: JAYBIRD LLC, Salt Lake City, UT (US)

(21) Appl. No.: 14/148,665

(22) Filed: Jan. 6, 2014

Related U.S. Application Data
(63) Continuation-in-part of application No. 14/062,815, filed on Oct. 24, 2013.

(51) Int. Cl. G06K 9/00; A41D 20/00

(52) U.S. Cl. CPC G06K 9/00342; A41D 20/00
USPC 700/91; 2/170

(57) ABSTRACT

A wearable activity monitoring device secured by a wristband with an interchangeable section comprises a first semi-elliptical component including a band element configured to hold an activity monitoring device capsule, the band element terminating on each end with a female connector that includes magnets and a pin receiving socket, and a second semi-elliptical component comprising a second band element terminating on each end with a male connector that includes a ferromagnetic connector pin configured to be magnetically secured inside a corresponding pin receiving socket when the two semi-elliptical components are joined.

### CROSS-REFERENCE TO RELATED APPLICATIONS

This application is a continuation-in-part of and claims the benefit of U.S. patent application Ser. No. 14/062,815, filed Oct. 24, 2013, titled “Wristband with Removable Activity Monitoring Device.” The contents of the Ser. No. 14/062,815 application are incorporated herein by reference.

### TECHNICAL FIELD

The present disclosure relates generally to fitness monitoring devices, and more particularly to wearable activity monitoring device with robust wristband.

### BACKGROUND

Previous generation movement monitoring and fitness tracking devices that are configured to be worn on a user's wrist generally enable only activity monitoring using an accelerometer. Those devices that also enable monitoring of pulse or heart rate variability (HRV), but require the user to wear a chest strap. One issue with currently available wearable devices is that they either require the user to wear the additional chest strap, or are limited in functionality to monitoring only feedback from the accelerometer. Another issue with these devices is that the wearable band is not easily configurable. Some wearable devices either only fit one size wrist, or require the use of an adjustable strap with a buckle mechanism, similar to the mechanism to adjust a wristwatch. Such devices are not comfortable for the user to wear twenty-four hours per day, and thus, monitoring user activity or sleep quality is not possible.

In view of these drawbacks, there exists a need for wearable fitness monitoring devices, capable of monitoring user activity and biofeedback, including HRV, twenty-four hours a day using a comfortable and easily configurable wristband.

### BRIEF SUMMARY OF THE DISCLOSURE

The present disclosure is directed towards activity monitoring devices. In particular, embodiments of the present invention are directed towards a wearable activity monitoring device with a robust band design that is easily configurable and provides adequate comfort for the wearer.

One embodiment of the disclosure provides a robust wristband with an interchangeable section that includes a first semi-elliptical component comprising a band element with a female connector protruding from each of its terminal ends and a second semi-elliptical component comprising a second band element with a male connector protruding from each of its terminal ends. two male connectors, wherein a lateral edge of each male connector is configured to couple to an opposing lateral edge of a corresponding female connector such that the first semi-elliptical component couples to the second semi-elliptical component to form a complete elliptical wristband. In many embodiments, the male connectors include connector pins and the female connectors include pin receiving sockets configured to accept the connector pins and further secure the semi-elliptical components together. In some examples of the disclosure, the male connectors and/or connector pins are ferromagnetic and the female connectors include magnets to magnetically couple the two semi-elliptical components together.

The second semi-elliptical component may be interchangeable with semi-elliptical components of varying dimensions. Accordingly, a user with a larger wrist may increase the size of the wristband by interchanging the second semi-elliptical component with one of larger radial dimension, and a user with a smaller wrist may decrease the size of the wristband by interchanging the second semi-elliptical component with one of smaller radial dimension.

In several embodiments of the disclosure, the first semi-elliptical component is configured to secure an activity monitoring device. The activity monitoring device may be an electronic capsule. For example, the first band element may include a cavity notched on a radially inward side shaped to substantially match the profile of the electronic capsule such that the electronic capsule may be form-fit in place when positioned in the cavity. The cavity may include an aperture shaped to substantially match the profile of a finger biosensor positioned on a radially outward surface of the electronic capsule such that the finger biosensor protrudes through the aperture when the electronic capsule is positioned inside of the cavity. In some examples of the disclosure, the electronic capsule may conceal magnets inside its watertight enclosure, and the first band element may conceal a ferromagnetic element located within the cavity to magnetically secure the electronic capsule in place in the cavity.

The band elements may be made of silicone, rubber, leather, plastic, metal links, or other flexible materials that may be formed to comfortably match the shape of a human wrist as would be known to one of ordinary skill.

Other features and aspects of the disclosure will become apparent from the following detailed description, taken in conjunction with the accompanying drawings, which illustrate, by way of example, the features in accordance with embodiments of the disclosure. The summary is not intended to limit the scope of the disclosure, which is defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments of the disclosure.

FIG. 1 illustrates a cross-sectional view of a non-robust wristband and electronic module of a wearable activity monitoring device.

FIG. 2 illustrates a perspective view of a non-robust wristband and electronic module of a wearable activity monitoring device.

FIG. 3 illustrates a cross-sectional view of a non-robust wristband and electronic module of a wearable activity monitoring device.

FIG. 4 illustrates a side view of an example electronic capsule.

FIG. 5 illustrates a cross-sectional view of an example electronic capsule.

FIG. 6 illustrates perspective views of non-robust wristbands.

FIG. 7 illustrates a perspective view of an activity monitoring device with a robust wristband with interchangeable section.

FIG. 8 is a perspective view of first half and a second half of a robust wristband.

FIG. 9 is an exploded view of an activity monitoring device with a robust wristband.

The figures are not intended to be exhaustive or to limit the disclosure to the precise form disclosed. It should be understood that the disclosure can be practiced with modification and alteration, and that the disclosure can be limited only by the claims and the equivalents thereof.

### DETAILED DESCRIPTION

Embodiments of the present disclosure are directed toward a wearable activity monitoring device secured by a robust wristband with an interchangeable section.

According to some embodiments of the disclosure, a wearable activity monitoring device secured by a robust wristband with an interchangeable section includes an electronic capsule encased in a watertight enclosure and a robust wristband with an interchangeable section. The robust wristband with an interchangeable section may include a first semi-elliptical component comprising a first band element and two rectangular male connectors, wherein one male connector protrudes circumferentially from each terminal end of the first band element and a ferromagnetic connector pin protrudes from each male connector, and a second semi-elliptical component comprising a second band element and two female connectors comprising magnets, wherein one female connector protrudes circumferentially from each terminal end of the second band element and each female connector includes a pin receiving socket configured to accept the connector pin of a corresponding male connector when the semi-elliptical components are coupled, and wherein the first band element includes a cavity notched on a radially inward side, the cavity shaped to substantially match the profile of the electronic capsule such that the electronic capsule is form-fit in place when positioned in the cavity.

In several embodiments, the female connectors are located on the first semi-elliptical component and the male connectors are located on the second semi-elliptical component. The second semi-elliptical component may be interchanged with semi-elliptical components of varying dimensions to enable users with different sized wrists to easily adjust the size of the wristband. The band elements may be made of silicone, rubber, leather, plastic, metal links, or other flexible materials that may be formed to comfortably match the shape of a human wrist as would be known to one of ordinary skill.

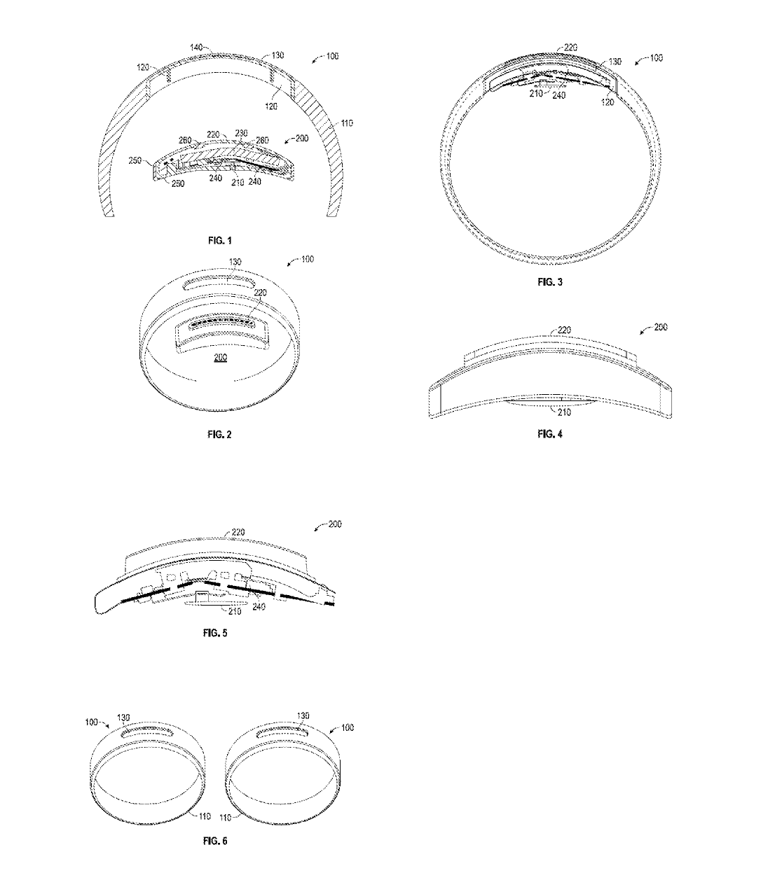

FIGS. 1 through 6 illustrate a wearable activity monitoring device as used with a non-robust wristband for comparison purposes with the robust, configurable wristband disclosed herein. FIG. 1 is a diagram illustrating a cross-sectional view of an example of an activity monitoring device affixed to a non-robust wristband. Referring now to FIG. 1, an activity monitoring device comprises an electronic capsule 200 and a wristband 100. The electronic capsule 200 comprises a wrist biosensor 210, a finger biosensor 220, a battery 230, one or more logic circuits 240, and a casing 250.

In some embodiments, the one or more logic circuits 240 comprise an accelerometer, a wireless transmitter, and circuitry. The logic circuits may further comprise a gyroscope. These logic circuits may be configured to process electronic input signals from the biosensors and the accelerometer, store the processed signals as data, and output the data using the wireless transmitter. The transmitter is configured to communicate using available wireless communications standards. For example, in some embodiments, the wireless transmitter may be a Bluetooth® transmitter, a Wi-Fi transmitter, a GPS transmitter, a cellular transmitter, or some combination thereof. In an alternative embodiment, the wireless transmitter may further comprise a wired interface (e.g. USB, fiber optic, HDMI, etc.) for communicating stored data.

The logic circuits 240 may be electrically coupled to the wrist biosensor 210 and the finger biosensor 220. In addition, the logic circuits are configured to receive and process a plurality of electric signals from each of the wrist biosensor 210 and finger biosensor 220. In some embodiments, the plurality of electric signals comprise an activation time signal and a recovery time signal such that the logic circuits 240 may process the plurality of signals to calculate an activation recovery interval equal to the difference between the activation time signal and the recovery time signal. In some embodiments, the plurality of signals may comprise electro-cardio signals from a heart, and the logic circuits may process the electro-cardio signals to calculate and store a RR-interval, and the RR-interval may be used to calculate and store a heart rate variability (HRV) value. Here, the RR-interval is equal to the delta in time between two R-waves, where the R-waves are the electro-cardio signals generated by a ventricle contraction in the heart.

In some embodiments, the logic circuits may further detect and store metrics such as the amount of physical activity, sleep, or rest over a recent time period, or the amount of time without physical activity over a recent period of time. The logic circuits may then use the HRV, or the HRV in combination with said metrics, to calculate a recovery score. For example, the logic circuits may detect the amount of physical activity and the amount of sleep a user experienced over the last 48 hours, combine those metrics with the user's HRV, and calculate a recovery score of between 1 and 10, wherein the recovery score could indicate the user's physical condition and aptitude for further physical activity that day. The recovery score may also be calculated on a scale of between 1 and 100, or any other scale or range.

Wristband 100 comprises a material 110 configured to encircle a human wrist. In one embodiment, wristband 100 is adjustable. A cavity 120 is notched on the radially inward facing side of the wristband and shaped to substantially the same dimensions as the profile of the electronic capsule. In addition, an aperture 130 is located in the material 110 within cavity 120. The aperture 130 is shaped to substantially the same dimensions as the profile of the finger biosensor 220. The cavity and aperture combination is designed to detachably couple to the electric capsule 200 such that, when the electric capsule 200 is positioned inside cavity 120, the finger biosensor 220 protrudes through the aperture 130. Electronic capsule 200 may further comprise one or more magnets 260 configured to secure capsule 200 to cavity 120. Magnets 260 may be concealed in casing 250. Alternatively, cavity 120 may be configured to conceal magnets 260 when electric capsule 200 detachably couples to the cavity and aperture combination.

Wristband 100 may further comprise a steel strip 140 concealed in material 110 within cavity 120. In this embodiment, when the electronic capsule 200 is positioned within the cavity 120, the one or more magnets 260 are attracted to the steel strip 140 and pull electronic capsule 200 radially outward with respect to the wristband. The force provided by magnets 260 may detachably secure electronic capsule 200 inside cavity 120. In alternative embodiments, the electronic capsule may be positioned inside the wristband cavity and affixed using a form-fit, press-fit, snap-fit, friction-fit, VELCRO, or other temporary adhesion or attachment technology.

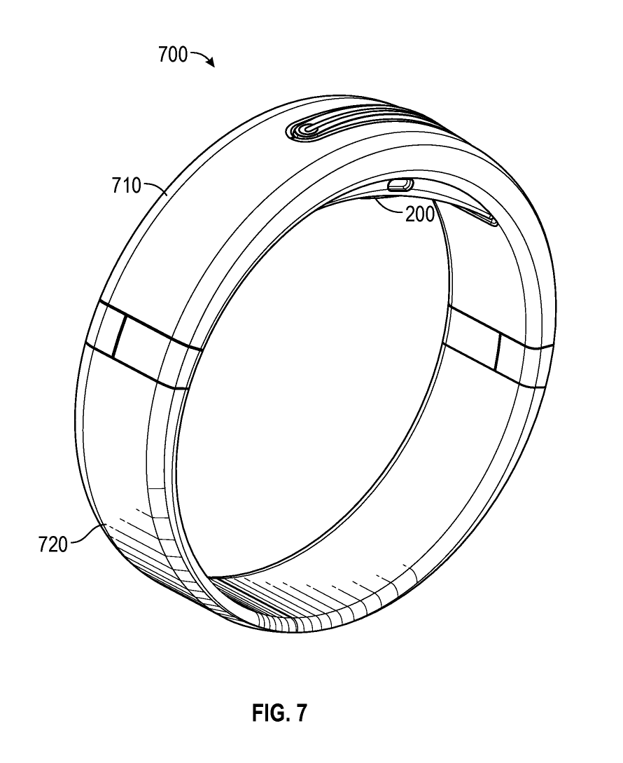

FIG. 2 illustrates a perspective view of one embodiment of the disclosed activity monitoring device, in which wristband 100 and electronic capsule 200 are unassembled. FIG. 3 illustrates a cross-sectional view of one embodiment of a fully assembled wristband with removable athletic monitoring device. FIG. 4 illustrates a side view of an electronic capsule 200 according to one embodiment of the disclosure.

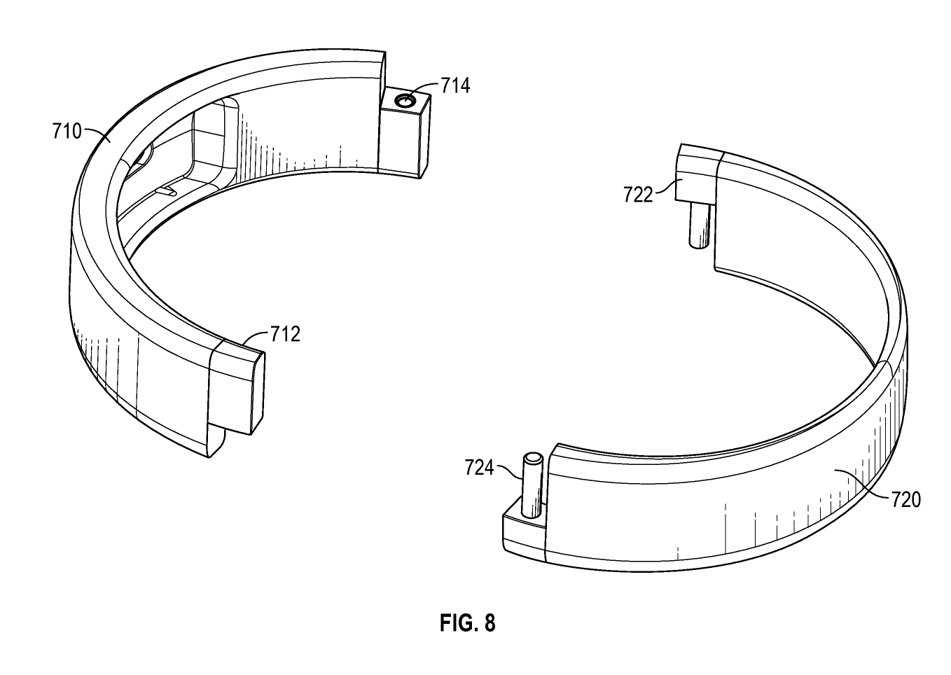

FIG. 5 illustrates a cross-sectional view of electronic capsule 200. FIG. 6 is a perspective view of two possible variants of the wristband according to some embodiments of the disclosure. Wristbands may be constructed with different dimensions, including different diameters, widths, and thicknesses, in order to accommodate different human wrist sizes and different preferences.

In some embodiments of the disclosure, the electronic capsule may be detachably coupled to a cavity on a shoe and/or a sock. In other embodiments, the electronic capsule may be detachably coupled to sports equipment. For example, the electronic capsule may be detachably coupled to a skateboard, a bicycle, a helmet, a surfboard, a paddle boat, a body board, a hang glider, or other piece of sports equipment. In these embodiments, the electronic capsule may be affixed to the sports equipment using magnets. Alternatively, in other embodiments, the electronic capsule can be affixed using a form-fit, snap-fit, press-fit, friction-fit suction cup, VELCRO, or other technology that would be apparent to one of ordinary skill in the art.

In one embodiment of the disclosure, the electronic capsule may further comprise an optical sensor such as a heart rate sensor or oximeter. In this embodiment, the optical sensor may be positioned to face radially inward towards a human wrist when the wristband is fit on the human wrist. Alternatively, the optical sensor may be separate from the electronic capsule, but still detachably coupled to the wristband and electronically coupled to the circuit boards enclosed in the electronic capsule. Wristband 100 and electronic capsule 200 may operate in conjunction with a system for providing a smart activity score.

FIG. 7 is a perspective view of an activity monitoring device with a robust wristband. Referring now to FIG. 7, electronic capsule 200 may also be attached to a robust wristband 700. Robust wristband 700 includes two semi-elliptical components 710 and 720. When element 710 and 720 are coupled, the resulting wristband may be similar in shape, material, and function to the wristband described in FIGS. 1 through 6. A first, or top semi-elliptical component, 710, may include a notched cavity and aperture contained therein configured to accept the electronic capsule 200. A second, or bottom semi-elliptical 720 may be interchangeable with multiple alternate semicircular wristband sections of varying radial dimension, such that the assembled wristband size may be adjusted by swapping semi-circular element 720 with other wristband sections of varying dimensions. The wristband material may be silicone, rubber, leather, plastic, metal links, or other flexible materials or combinations of materials that may be formed to comfortably match the shape of a human wrist as would be known to one of ordinary skill.

FIG. 8 is a perspective view of a first semi-elliptical component and a second semi-elliptical component of a robust wristband. Referring now to FIG. 8, the first, or top semi-elliptical component 710, includes a first band element and two female connectors 712. The second, or bottom semi-elliptical component 720 includes a second band element and two male connectors 722. One female connector 712 protrudes circumferentially from each terminal end of the first band element and one male connector 722 protrudes circumferentially from each terminal end of the second band element. A lateral edge of each male connector 722 is configured to couple to an opposing lateral edge of a corresponding female connector 712 such that the first semi-elliptical component couples to the second semi-elliptical component to form a complete elliptical wristband, as illustrated in FIG. 7.

Still referring to FIG. 8, each protruding male connectors 722 may be shaped to match the profile of the band element from which it protrudes with an outside lateral edge of the male connector being flush with an outside edge of the band element. However, the male connector width is less than the band element's width, giving the appearance of a notched terminal end of the semi-elliptical section 720. Each male connector 722 may include a connector pin 724 that protrudes perpendicularly from the inside lateral edge of the male connector.

Still referring to FIG. 8, each protruding female connector 712 may also be shaped to match the profile of the band element from which it protrudes, with an outside lateral edge of the female connector being flush with an outside edge of the band element. However, the female connector width is less than the band element's width, giving the appearance of a notched terminal end of the semi-elliptical section 710. Each female connector 712 may include a pin receiving socket, slot, or notch 714, located on its inside lateral edge, that is configured to accept the connector pins from the corresponding male connectors when the two semi-elliptical components are joined together. The connector pins may fit tightly inside the pin receiving sockets to create a form fit, push fit, or snap fit.

In some embodiments, the connector pins 724 and/or male connectors may be ferromagnetic and the female connectors 712 may include magnets such that the two semi-elliptical components may magnetically couple together. Other mechanical coupling methods may be used as would be known to one of ordinary skill in the art.

In many examples of the disclosure, the combined width of the female connectors 712 and the male connectors 722 approximately matches the width of the band elements such that the profile of the male and female connectors, when coupled together, approximately matches the profile of the band elements. Accordingly, when the two semi-elliptical components are joined together, the profiled of the entire elliptical wristband is uniform.

In some examples of the disclosure, the outside lateral edge of a first female connector 712 on a first terminal end of semi-elliptical component 710 is flush with a first edge of semi-elliptical component 710, and the outside lateral edge of a second female connector 712 on a second terminal end of semi-elliptical component 710 is flush with a second edge of semi-elliptical component 710. Similarly, in this example, as illustrated by FIG. 8, the male connectors 722 may form the reverse configuration on the terminal ends of semi-elliptical component 720. Accordingly, the outside lateral edge of a first male connector 722 on a first terminal end of semi-elliptical component 720 is flush with a second edge of semi-elliptical component 720, and the outside lateral edge of a second male connector 722 on a second terminal end of semi-elliptical component 720 is flush with a first edge of semi-elliptical component 720. With this configuration, the first semi-elliptical component 710 may be coupled to the second semi-elliptical component 720 by twisting the two elements in opposite directions, such that a first connector pin 724 moves upward into its corresponding first pin-receiving socket 714 while a second connector pin 724 on the opposite side of semi-elliptical component 720 moves downward into its corresponding second pin-receiving socket 714.

In many examples of the disclosure, the male connectors 722 and female connectors 712 are die-cast. In other examples, these connector components may be injection molded, or formed using other molding technologies as would be known to one of ordinary skill in the art.

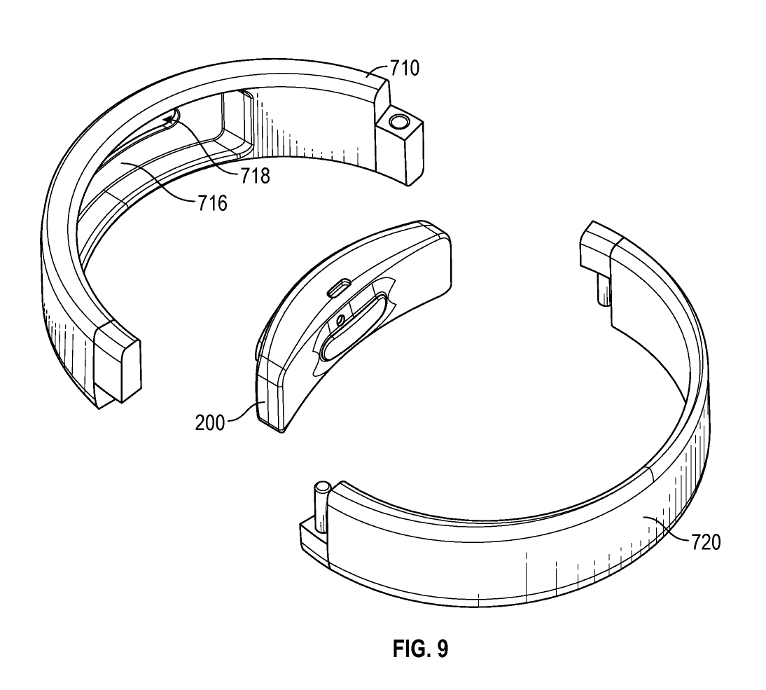

FIG. 9 is an exploded view of the robust wristband. Referring now to FIG. 9, top half 710 may be notched with accepting notch 716 and aperture 718 on a radially inward facing side of the wristband, similar to the wristband 100 shown in FIGS. 1, 2, and 3. Electronic capsule 200 may then be magnetically secured by metal strips contained within the top half 710, in the same way that the electronic capsule is fit into wristband 100 as shown in FIGS. 1, 2, and 3. The electronic capsule may also be snap fit, form fit, or secured in notch 716 using other methods known in the art.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

What is claimed is:

1. A wristband with an interchangeable section, comprising:
a first semi-elliptical component comprising a first band element and two female connectors; and
a second semi-elliptical component comprising a second band element and two male connectors;
wherein one female connector protrudes circumferentially from each terminal end of the first band element;
one male connector protrudes circumferentially from each terminal end of the second band element; and
a lateral edge of each male connector is configured to couple to an opposing lateral edge of a corresponding female connector such that the first semi-elliptical component couples to the second semi-elliptical component to form a complete elliptical wristband.

2. The interchangeable wristband of claim 1, wherein the band elements comprise silicone, rubber, leather, plastic, or metal.

3. The interchangeable wristband of claim 1, wherein each female connector comprises magnets and each male connector comprises ferromagnetic material, such that the female connectors magnetically couple to the male connectors.

4. The interchangeable wristband of claim 3, wherein the ferromagnetic material is iron or nickel.

5. The interchangeable wristband of claim 1, wherein the width of the first band element equals the width of the second band element and the sum of the widths of any male connector and any female connector is no more than the width of each band element.

6. The interchangeable wristband of claim 1, wherein the second semi-elliptical component is interchangeable with other semi-elliptical components of varying dimensions.

7. The interchangeable wristband of claim 1, wherein each male connector comprises a connector pin and each female connector includes a pin receiving socket configured to accept the connector pin of a corresponding male connector when the semi-elliptical components are coupled.

8. The interchangeable wristband of claim 7, wherein the connector pin of each male connector is configured to form fit or snap fit into the pin receiving socket of the corresponding female connector.

9. The interchangeable wristband of claim 8, wherein each connector pin comprises ferromagnetic material and each female connector comprises one or more magnets.

10. A system for securing an activity monitoring device to a wrist, comprising:
an interchangeable wristband; and
an activity monitoring device comprising an electronic capsule encased in a watertight enclosure.

11. The system for securing an activity monitoring device to a wrist of claim 10, wherein the interchangeable wristband comprises:
a first semi-elliptical component comprising a first band element and two female connectors; and
a second semi-elliptical component comprising a second band element and two male connectors;
wherein one female connector protrudes circumferentially from each terminal end of the first band element;
one male connector protrudes circumferentially from each terminal end of the second band element; and
a lateral edge of each male connector is configured to couple to an opposing lateral edge of a corresponding female connector such that the first semi-elliptical component couples to the second semi-elliptical component to form a complete elliptical wristband.

12. The system for securing an activity monitoring device to a wrist of claim 11, wherein the first band element includes a cavity notched on a radially inward side shaped to substantially match the profile of the electronic capsule such that the electronic capsule is form-fit in place when positioned in the cavity.

13. The system for securing an activity monitoring device to a wrist of claim 12, wherein an aperture is located within the cavity, the aperture being shaped to substantially match the profile of a finger biosensor positioned on a radially outward surface of the electronic capsule such that the finger biosensor protrudes through the aperture when the electronic capsule is positioned inside of the cavity.

14. The system for securing an activity monitoring device to a wrist of claim 13, wherein the electronic capsule further comprises one or more magnets concealed inside the watertight enclosure and the first band element further comprises a ferromagnetic element located within the cavity, such that the one or more magnets are magnetically attracted to the ferromagnetic element, thereby holding the electronic capsule in place when the electronic capsule is positioned in the cavity.

15. The system for securing an activity monitoring device to a wrist of claim 11, wherein the first and second band elements comprise silicone, rubber, leather, plastic, or metal.

16. The system for securing an activity monitoring device to a wrist of claim 11, wherein the female connectors comprise magnets and the male connectors comprise ferromagnetic material, such that the female connectors magnetically couple to the male connectors.

17. The system for securing an activity monitoring device to a wrist of claim 11, wherein the second semi-elliptical component is interchangeable with other semi-elliptical components of varying radial dimension.

18. The system for securing an activity monitoring device to a wrist of claim 11, wherein each male connector comprises a connector pin and each female connector comprises a rectangular element with a pin receiving socket configured to accept the connector pin of the corresponding male connector when the semi-elliptical components are coupled.

19. The system for securing an activity monitoring device to a wrist of claim 11, wherein the connector pin of each male connector is configured to form fit or snap fit into the pin receiving socket of the corresponding female connector.

20. An activity monitoring device comprising:
an electronic capsule encased in a watertight enclosure; and
an interchangeable wristband, the wristband comprising:
a first semi-elliptical component comprising a first band element and two rectangular male connectors, wherein one male connector protrudes circumferentially from each terminal end of the first band element and a ferromagnetic connector pin protrudes from each male connector; and
a second semi-elliptical component comprising a second band element and two female connectors comprising magnets, wherein one female connector protrudes circumferentially from each terminal end of the second band element and each female connector includes a pin receiving socket configured to accept the connector pin of a corresponding male connector when the semi-elliptical components are coupled; and
wherein the first band element includes a cavity notched on a radially inward side, the cavity shaped to substantially match the profile of the electronic capsule such that the electronic capsule is form-fit in place when positioned in the cavity.
